(19) United States
(12) Patent Application Publication
(10) Pub. No.: US 2006/0094578 A1
(43) Pub. Date: May 4, 2006

(54) Cover for cardboard composite beverage packages, tools and methods for producing such a cover, and cardboard composite beverage packages provided therewith

(76) Inventor: Matthias Dammers, Alsdorf (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/519,880

(22) PCT Filed: Jun. 30, 2003
(86) PCT No.: PCT/EP03/06944

§ 371 Date: Aug. 17, 2005

(30) Foreign Application Priority Data
Jul. 3, 2002 (DE) 102 30 001.1

(51) Int. Cl. B31B 1/84

(52) U.S. Cl. 493/87

(57) ABSTRACT

The present invention is directed to a cap for laminated carton packaging for beverages, wherein the laminated carton packaging for beverages comprise a cap made of plastic and a packaging body, tools for deep drawing of such a cap, method of manufacturing such a cap as well as the laminated carton packaging for beverages provided therewith. In order to create a constructively simple to assemble and therefore cost-effective cap which can be manufactured and to make available the respective tools as well as the method for their manufacture, it is provided that the cap has a spout element provided with a screw thread which is closed by a screw cap and that the cap is deep drawn. For this purpose various tools and manufacturing methods are described.

The invention relates to a cap for laminated carton packaging for beverages wherein the laminated carton packaging for beverages comprises a plastic cap and a packaging body, wherein the cap has a spout element provided with a screw thread and wherein the cap is deep-drawn. Further, the invention relates to tools for deep drawing such a cap, corresponding methods for its manufacture and a laminated carton packaging for beverages provided with such a cap.

Laminated carton packaging for beverages in various forms have been known for a long time. In addition to packaging consisting completely of a carton/plastic laminate, packaging also exist comprising a plastic cap and a packaging body made of carton/plastic laminated material and such comprising a jacket formed from a hollow body and, respectively, an associated cap and bottom, preferably made of plastic, wherein both the shape of the packaging as well as its stability is generally determined by the geometry of the bottom and the cap. It is readily apparent, in particular, that when the bottom and the cap are made of plastic, the packaging can be given almost any cross-sectional profile.

Moreover, it is also known to have laminated carton packaging for beverages provided with spout elements. In this respect, the practice has prevailed to design spout elements to be reclosable. This can be realized, for example, by a hinged lid or by a screwable screw cap as the closure. Since the spout elements described beforehand in detail are generally made of plastic, it is obvious to manufacture the cap as well as the spout element located on top integrally out of plastic.

A cap for laminated carton packaging for beverages initially mentioned and described above in more detail is known from EP 0 505 851 A1. The manufacture of this conventional cap in the deep drawing method, however, is disadvantageous because the screw thread of the spout element is deformed directly into the screw cap located in the deep drawing tool. To facilitate the opening, it is necessary in this prior art that the cap with the spout element be sealed with a sealing mandrel in the area of the later opening, in order to produce an opening for pouring upon initial opening through destruction of the plastic material above the spout element. The conventional solution for this is not only complicated in construction, but requires that the screw cap has at least one ventilation channel in order to enable the deep drawing procedure. Such a channel, however, is not desirable since dust or even germs can be picked up during transportation and storage of packages provided with such caps, which could come into contact with the product when pouring. Furthermore, it is not possible in the known cap to fill a beverage package provided with such a cap through the spout opening of the spout element. This is always desirable, however, when the form of the beverage packaging requires the connection of the cap to the packaging before the filling procedure.

The object of the invention is to provide a cap with an integrally formed spout element that is simple in construction and thus can be manufactured cost-effectively for laminated carton packaging for beverages which also allows a filling of these packaging through the spout element and a corresponding tool as well as method for its manufacture.

With respect to the cap, the object is solved in that the spout element has a spout opening which can be closed by a screw cap.

A first tool according to the invention is distinguished in that the deep drawing form has a thread feed pipe which can be driven out and which before the deep drawing procedure can be moved out of the tool body into a working position, preferably via a spindle drive and is unscrewed from of the rigid plastic cap after the deep drawing procedure.

An alternative tool according to the invention is characterised in that the deep drawing form has a tube arranged with threadlike recesses, and that under the tube a spreading tool is arranged with a plurality of elevations corresponding to the division of the spreading tool and executed as thread course, which in coinciding driven condition is moved into the tube and during the deep drawing procedure is expanded there so that the elevations of the spreading tool are moved by the recesses of the tube to the outside.

The manufacturing method concerning the first tool is characterised by the following steps:
supplying a plasticized foil over a deep drawing form having a projecting threaded feed pipe,
deep drawing of the foil,
releasing the deep drawn cap after unscrewing the thread feed pipe from the cap by screwing in the tool form and
punching out the cap and spout opening.

The manufacturing method concerning the second designated tool has the following steps:
supplying a plasticized foil over a deep drawing form having a tube and a spreading tool,
spreading of the spreading tool,
deep drawing of the foil over the thread turns of the spread out spreading tool inside the tube,
releasing the deep drawn cap after driving together of the spreading tool forming the threads and
punching out of cap and pouring spout.

The invention has recognised that it is possible to also provide deep drawn caps with a screw-spout element if the associated tools are formed corresponding to the above-named features.

The geniality of the invention is based on the fact that it is also possible to manufacture a plastic cap with a one-piece shaped screw neck in the deep drawn method in which the part of the tool located in the interior of the screw neck before the release of the deep drawn cap is pushed back inside of the tool body in order to release the cap also-in the area of the screw thread.

In a first alternative of the solution according to the invention, the tool has a thread feed pipe which by means of a spindle or suchlike is moveable out of the tool body and can be moved back into the latter again. In this respect, it is clear that the lead of the screw spindle has to correspond to the lead of the thread feed pipe. The invention has recognized that it is readily possible to manufacture a cap with a formed spout element with a screw threading in the deep drawn method if the screw thread serves not only as outer thread for the reception of the screw cap, but also serves as the inner thread in addition to drive out the screw neck before the removal of the deep drawn cap.

Alternatively, it was apparent that for a secure closure of the screw cap onto the spout element it is not necessary that its thread turns run continuously. If the thread does not have to assume any sealing functions because this can be realised sufficiently well in the level of the actual spout opening, the caps according to the second solution of the invention can also be manufactured in the deep drawing method in which the spreading tool similar to a chuck can be brought into the working position. For this purpose, the spout element can have a screw thread with at least one thread turn and the at least one thread turn consists of various thread sections arranged with a distance to one another and aligned with one another.

Preferably, a deep drawing monomer foil or a deep drawing multilayer foil is used as the plastic for the cap. The use of a deep drawing multilayer foil is especially preferred since in this connection a foil can be used which can have oxygen and/or aroma barrier properties. In this way, the laminated carton beverage packaging provided with the cap according to the invention are also suited for sensitive products which, for example, have to be reliably protected against light or oxygen.

According to a further teaching of the invention, the cap is provided with a circumferential, upward angled edge enabling a seal connection with the jacket material. It is also possible, however, to manufacture a cap with an downward angled edge with the tool according to the invention, respectively, method. For this purpose, the deep drawing form has a corresponding circumferential channel in which the plasticized plastic material is initially pulled it and wherein the cap is then punched out along the inner edge.

Finally, it is also possible to provide a cap with a upward angled edge with an concentric adjacent collar with a slight outward pitch and downward running periphery in which the width of the slot thereby created substantially corresponds to the material thickness of the carton/plastic laminate. Such a cap can be pulled over the upper packaging edge after filling and subsequently pressed with the latter.

For hygienic purposes and furthermore as originality closure, a further embodiment of the invention provides that the spout opening of the spout element is sealed with a sealing film. In this way, it is clearly indicated to the consumer that the packaging contents are still originally sealed and therefore protected against unauthorised manipulation after filling. Alternatively, it is also conceivable, however, that the screw cap is screwed liquid-tight onto the spout element before the package standing upside down is filled through the still not closed bottom.

For the sake of completeness, it is mentioned that the parts of the deep drawing form driven out of the tool body can be tempered in order to enable a more rapid cooling of the cap after the deep drawing procedure.

For the case of the deep drawing form with spreading tool, a further embodiment of the invention provides that the tube and the spreading tool of the deep drawing tool is made slightly conical. A slight concality of the spreading tool facilitates the driving out of the tube of the deep drawing form, however within the framework of the invention it is not absolutely necessary. Preferably, the spreading tool consists of three spreading elements whose elevations are correspondingly coordinated with one another for the formation of the later thread.

In a further embodiment of the invention, it is also possible that the addition of the plasticized foil over the deep draw form and the spreading of the spreading tool in the interior of the tube-occurs simultaneously.

In addition, with both tools and manufacturing methods, respectively, after the actual deep drawing procedure according to a further teaching of the invention the release of the deep drawn cap and the punching out of the cap and the spout opening can take place simultaneously. For this purpose a knife can be provided inside the tool.

Finally the invention relates to a laminated carton packaging for beverages with a cap according to the invention. In this connection, the packaging body can consist of a carton/plastic laminate material or of carton/plastic/aluminium composite material. It is also possible that the packaging body consists of a jacket of carton/plastic laminate material, respectively, carton/plastic/aluminium composite material and a bottom preferably made of plastic.

The invention is explained in more detail in the following on the basis of a drawing illustrating only preferred embodiments. In the drawing

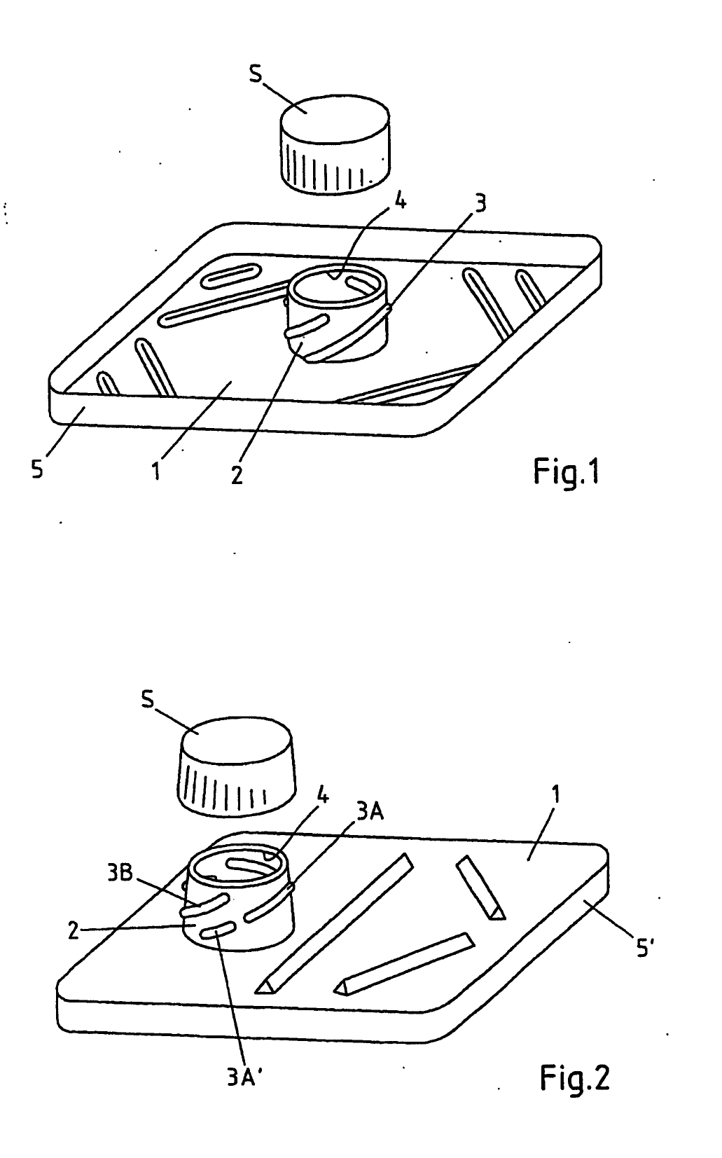

FIG. 1 shows a first embodiment of a cap according to the invention without the screw cap in perspective view,

FIG. 2 shows a second embodiment of a cap according to the invention with a screw cap removed in perspective view,

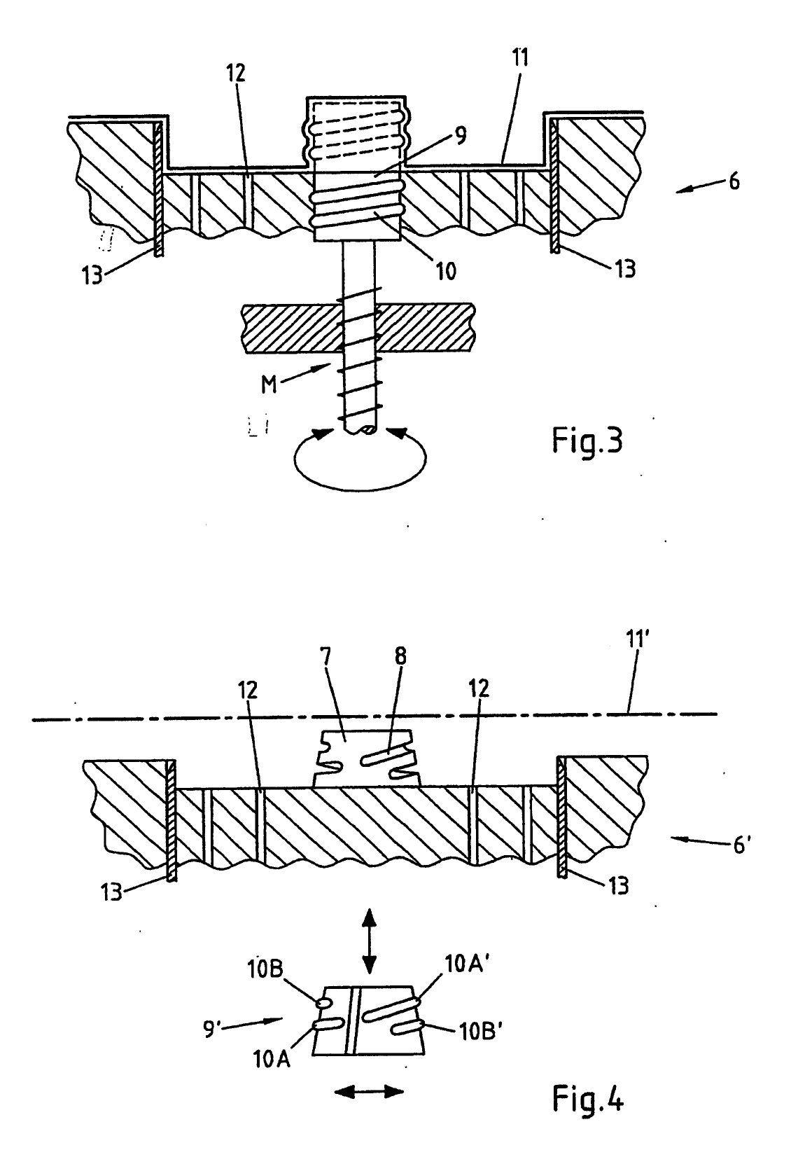

FIG. 3 shows schematically in cross-sectional view a first embodiment of a tool-according to the invention for deep drawing of a cap according to the invention,

FIG. 4 shows schematically in cross-sectional view a second embodiment of a tool according to the invention for deep drawing of a cap according to the invention,

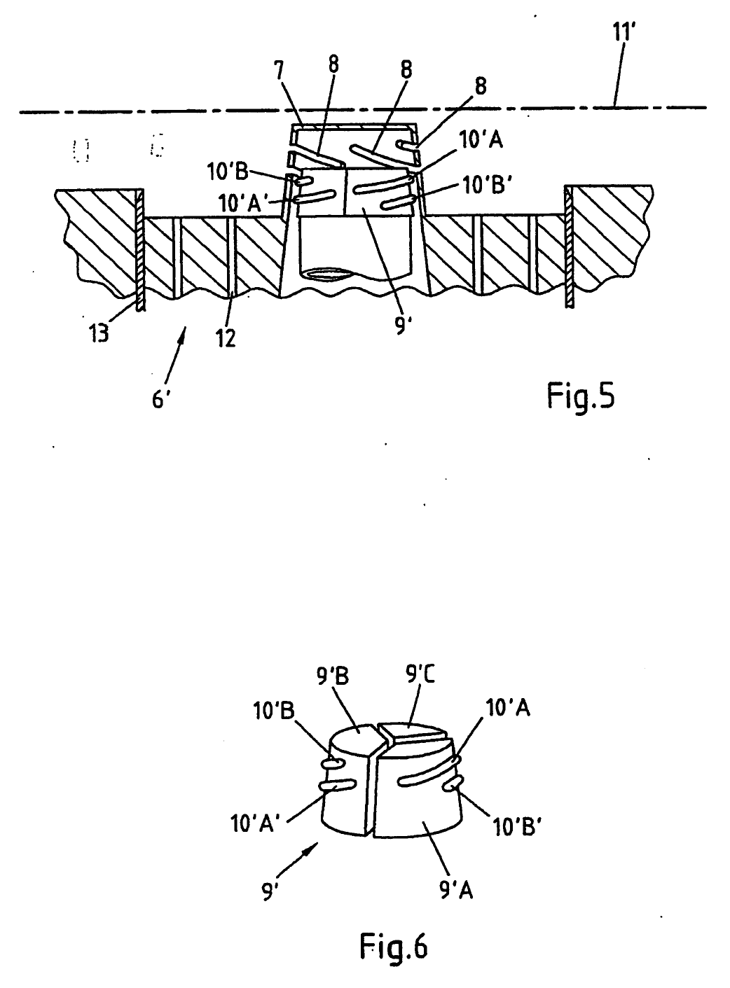

FIG. 5 shows the tool of FIG. 4 in vertical section through the tube,

FIG. 6 shows the spreading tool from FIG. 5 in perspective view,

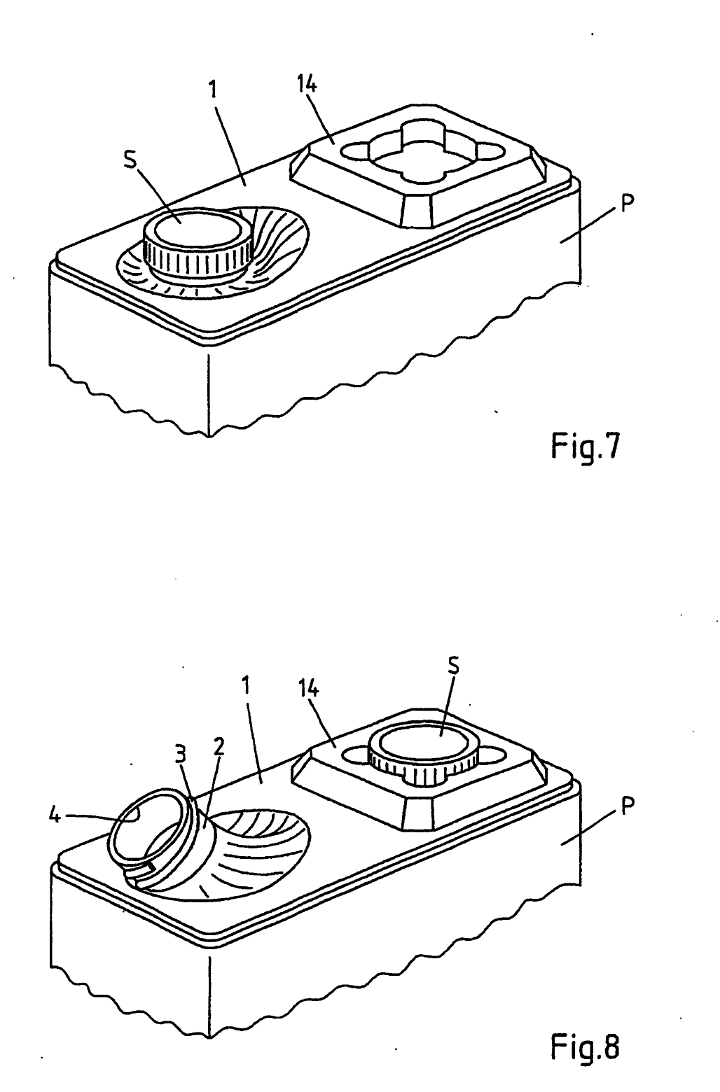

FIG. 7 shows the upper part of a laminated carton packaging for beverages with a cap according to the invention in transportation position and in perspective view, and

FIG. 8 shows the upper part of an laminated carton packaging for beverages with a cap according to the invention in the pouring position and in perspective view.

FIGS. 1 and 2 show a cap 1 according to the invention for laminated carton beverage packaging having a spout element 2 in the illustrated embodiment arranged in the center (FIG. 1):, respectively, laterally (FIG. 2), which is provided with a thread 3 and a spout opening 4 for emptying the contents of the package. Whereas the thread 3 in FIG. 1 shows continuous thread turns, the thread in FIG. 2 consists of several thread sections 3A, 3B, 3A′ arranged with a distance to each other and aligned with each other. A circumferential, upward angled edge 5 serves for the sealed connection of the cap 1 with the packaging jacket (not shown). In FIG. 2 is a corresponding, however, downward angled edge 5′ illustrated.

From FIGS. 1 and 2 it can be further gathered that the cap can have elevations or ribs not further specified which, on the one hand, can be provided to increase the stability of the cap and on the other hand, in order to provide the cap with aesthetic (for example exalted writing, logos or suchlike) or functional (for example, stiffening or elements to improved stackability) design elements.

In a first tool according to the invention as per FIG. 3, a deep drawing form 6 has a thread feed pipe 9 which is located inside the deep drawing body 6 in the neutral position. The thread feed pipe 9 has one or more thread turns 10 which are taken up by a corresponding thread turn of the tool body not described in detail. Before the deep drawing procedure, the thread feed pipe 9 is moved out of the neutral position via a spindle drive M shown only schematically into the operating position in which the thread feed pipe 9 is unscrewed from the tool body along its outer thread 10. In FIG. 3, the foil 11 is shown in rigid condition-after the deep drawing procedure. It is readily apparent that after cooling of the cap 1 the thread feed pipe 9 can be screwed back into the tool body so that an expedient removal of the cap is possible.

In FIG. 4 an alternative tool to manufacture the cap 1 in deep drawing method is shown schematically. The corresponding deep drawing form 6′ has a tube 7 arranged with threadlike recesses 8, under which a spreading tool 9′ is arranged, which in the illustrated and thus preferred embodiment is provided with three spreading elements 9′A, 9′B and 9′C , as also shown, in particular, in the perspective view in FIG. 6. The individual spreading elements have corresponding projections 10′ A, 10′ B, 10′ A′ and 10′ B′ which are moved outwardly during the deep drawing procedure in the interior of tube 7 by spreading the spreading tool 9′ through the recesses 8 of tube 7. In this way, at least one thread turn develops inside spout element 2 with several thread sections 3A, 3A′, 3B with a distance to each other and aligned with each other. In the preferred embodiment according to FIG. 4, tube 7 as well as the spreading tool 9 are executed slightly conical. A conical form is useful in particular in smallest spout cross sections since a better release is ensured in this way; however, it is not absolutely necessary.

In FIG. 5, the tool of FIG. 4 is now finally shown in more detail in the region of tube 7. The recesses 8 on the reverse side of tube 7 are clearly seen. The spreading tool 9′ is shown in FIG. 5 in non-spread condition. In this condition, it can be moved in and out of tube 7.

The manufacturing procedure in the second tool according to the invention takes place as follows:

From above, the deep drawing form 6 is supplied with a plasticized foil sheet 11′, which is only indicated by the dash-dotted line. At the same time, the spreading tool 9′ is moved axially into tube 7 and spread out there so that the thread turns of the now “finished” deep drawing tool are protuberant. In this connection, the deep drawing form 6′ is provided in the conventional manner with suction holes 12 only indicated, which are distributed evenly over the surface of the deep drawing form 6′. As seen in FIG. 2, an edge can be formed through deep drawing by means of the corresponding shaping of the deep drawing form 6. After deep drawing, spreading tool 9′ drives together radially and is moved axially out of tube 7. In both methods, only the cap 1 and the spout opening 4 are punched out. This can take place in a separate working step or already in the deep drawing tool. For this purpose, the deep drawing form 6, respectively, 6′ can have corresponding knives 13, which punch out the deep drawn cap out of the sheet 11, 11′.

Finally, a further embodiment of cap 1 according to the invention is illustrated in FIGS. 7 and 8. This cap with a no longer visible downward angled edge is attached in an laminated carton beverage packaging P indicated only in its upper region. In this connection, the transport position of packaging P is shown in FIG. 7 and in FIG. 8, its pouring position. It is apparent that the cap 1 is constructed as a membrane around the spout element 2 in order to achieve that the spout element 2 after the unscrewing of the screw cap 4 can be swivelled in the pouring direction with the plane of the pouring opening for a better handling and thus also to ensure the function during pouring. In the illustrated and thus preferred embodiment on the side opposite to the pouring element 2, cap 1 has an elevation 14 which has a depression in its interior large enough to receive the detached screw cap S, preferably clamped in. This elevation 14, however, also has advantages in the transportation position, as seen in FIG. 7, since it allows an even stacking of several packagings P arranged on top of each other without having the prominent spout element arranged on only one side cause problems.

1-24. (canceled)

25. A cap for a laminated carton packaging for beverages, wherein the cap:
is constructed of plastic;
includes a spout element having a screw thread and a spout opening designed to be closed by a screw cap; and
is deep drawn, further wherein the laminated carton packaging includes a packaging body.

26. The cap according to claim 25, wherein the spout element has a screw thread with at least one thread turn.

27. The cap according to claim 25, wherein the spout element has a screw thread with at least one thread turn and the at least one thread turn comprises several thread sections arranged with a distance to each other and aligned with each other.

28. The cap according to claim 25, wherein the plastic is a deep drawing monomer foil.

29. The cap according to claim 25, wherein the plastic is a deep drawing multilayer foil.

30. The cap according to claim 29, wherein the multilayer foil has at least one of oxygen and aroma barrier properties.

31. The cap according to claim 25, wherein the cap has a circumferential upward angled edge.

32. The cap according to claim 25, wherein the cap has a circumferential downward angled edge.

33. The cap according to claim 25, wherein the cap has a circumferential upward angled edge with a concentric adjacent collar with a slightly outward pitch and downward tapering periphery.

34. The cap according to claim 25, wherein the spout opening is sealed by a film before an unscrewing of the screw cap.

35. The cap according to claim 25, wherein the screw cap is screwed liquid-tight onto the spout element.

36. A tool for deep drawing a cap for a laminated carton packaging for beverages having a deep drawing form with a multitude of suction holes, comprising:
the deep drawing form including a thread feed pipe, wherein,
before a deep drawing procedure, the thread feed pipe is moved out of a tool body of the deep drawing form into a working position via a spindle drive; and
after the deep drawing procedure, the thread feed pipe is unscrewed out of the cap, further wherein the cap is formed of rigid plastic.

37. A tool for deep drawing a cap for laminated carton packaging for beverages with a deep drawing form having a multitude of suction holes, comprising:
the deep drawing form including a tube arranged with recesses formed as screw threads;
a spreading tool, positioned under the tube, arranged with a multitude of elevations executed as a thread turn corresponding to divisions of the spreading tool, wherein,
the spreading tool is driven into the tube during a deep drawing procedure thereby moving the elevations of the spreading tool outwardly through the recesses of the tube.

38. The tool according to claim 37, wherein the tube and the spreading tool have a slightly conical form.

39. The tool according to claim 37, wherein the spreading tool comprises three spreading elements.

40. The tool according to claim 36, wherein knives are arranged in the tool of the deep-drawing form for punching out at least one of the cap and the spout opening of the cap.

41. A method for manufacturing a cap for a laminated carton packaging for beverages, wherein the laminated carton packaging for beverages comprises a plastic cap and a packaging body, comprising the steps of:
supplying a plasticized foil over a deep drawing form having a thread feed pipe projecting out of a tool body;
deep drawing of the foil;
releasing of a deep drawn cap after an unscrewing of the thread feed pipe from the cap by means of screwing into the tool body; and
punching out the cap and a spout opening.

42. A method of manufacturing a cap for a laminated carton packaging for beverages, wherein the laminated carton packaging for beverages comprises a cap constructed from plastic and a packaging body, comprising the steps of:
supplying a plasticized foil over a deep drawing form having a tube and a spreading tool, wherein the spreading tool includes thread turns;
spreading out the spreading tool;
deep drawing the foil over the thread turns of the spreading tool, wherein the spreading tool is in a spread-out position;
releasing a deep drawn cap after coincided driving of the thread turns forming the spreading tool; and
punching out the cap and a spout opening.

43. The method according to claim 42, wherein the supplying of the plasticized foil over the deep drawing form and the spreading out of the spreading tools in an inside of the tube occur simultaneously.

44. The method according to claim 42, wherein the releasing of the deep drawn cap and the punching out of the cap and the spout opening occur simultaneously.

45. The method according to claim 41, wherein the releasing of the deep drawn cap and the punching out of the cap and the spout opening occur simultaneously.

46. A laminated carton packaging for beverages, comprising:
a cap; and
a packaging body,
wherein the cap:
is constructed of plastic;
includes a spout element having a screw thread and a spout opening designed to be closed by a screw cap; and
is deep drawn.

47. The laminated carton packaging for beverages with a cap according to claim 46, wherein the packaging body comprises carton/plastic/Al laminate material.

48. The laminated carton packaging for beverages with a cap according to claim 46, wherein the packaging body comprises a jacket constructed of carton/plastic laminate material and a bottom constructed of plastic.

49. The laminated carton packaging for beverages with a cap according to claim 46, wherein the packaging body comprises a jacket constructed of carton/plastic/Al laminated material and a bottom constructed of plastic.

50. The laminated carton packaging for beverages with a cap according to claim 46, wherein the packaging body comprises carton/plastic laminate material.
